(19) United States
(12) Patent Application Publication
(10) Pub. No.: US 2004/0122825 A1
(43) Pub. Date: Jun. 24, 2004

(54) Method, system, and program product for managing hierarchical structure data items in a database

(75) Inventor: David A. Pulaski, Lunenburg, MA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/326,187

(22) Filed: Dec. 20, 2002

(51) Int. Cl. G06F 7/00

(52) U.S. Cl. 707/100

(57) ABSTRACT

The invention manages hierarchical structure data items in a database by assigning a unique value having a sibling value to each data item. This allows child data items of a selected data item to be identified using a single non-recursive operation in which a logical relationship between the unique value assigned to the selected data item and a unique value assigned to each child data item is determined.

### BACKGROUND OF THE INVENTION

1. Field of the Invention

In general, the invention provides for the management of hierarchical structure data items in a database.

2. Background Art

It is often desirable to maintain various types of data in a hierarchical structure. For example, a catalog of products can be represented in a hierarchy (i.e., clothes/men/winter/gloves, etc.). Further, a relational database management system (RDBMS) is often desired to manage the data. As a result, several solutions have been proposed for maintaining data in a hierarchical structure in a relational database.

However, previous solutions often require a trade off between performance and the simplicity of the code. For example, obtaining hierarchical data often requires a recursive function call so that each branch of the tree can be traversed. While easily coded, the potentially large number of function calls often degrades performance. Further, several solutions require a performance trade off between performing a read operation on the hierarchical data versus performing an update or insert operation. Consequently, some parts of an application may perform well, while other parts perform poorly based on the selected trade off.

As a result, there exists a need for a method, system, and program product that manages various aspects of maintaining hierarchical data in a relational database efficiently.

### SUMMARY OF THE INVENTION

In general, the invention manages hierarchically related data items in a database by assigning unique values to each data item (i.e., node) in the hierarchy. Each unique value is based on a sibling value and a unique value assigned to the data item's parent. The unique value can be used to identify all relatives (e.g., children, grandchildren, parent, grandparent, siblings, etc.) of a data item based on logical relationships existing amongst the unique values. As a result, data items can be processed in an efficient and non-recursive fashion. For example, all data items located below a selected data item in a tree can be retrieved using a single non-recursive query operation. In a typical embodiment, each sibling in a set of siblings is assigned a sibling value that uniquely identifies it among all the siblings. A data item is assigned a unique value by combining (e.g., concatenating, prefixing, appending, inserting, etc.) its parent's unique value with its sibling value.

A first aspect of the invention provides a method of managing hierarchical structure data items in a database comprising: providing a relational database having hierarchically related data items; assigning a unique value to each data item, wherein each unique value includes a sibling value; and identifying all child data items of a selected data item using a single non-recursive operation, wherein the child data items are identified by determining a logical relationship between the unique value assigned to the selected data item and a unique value assigned to each child data item.

A second aspect of the invention provides a method of retrieving hierarchical structure data items from a database comprising: providing a relational database having data items; generating a unique string for each data item, the unique string including a sibling string; saving the unique string for each data item with each data item in the database; and retrieving all data items below a selected data item using a single non-recursive query based on the unique strings.

A third aspect of the invention provides a system for managing hierarchical structure data items in a relational database comprising: a value system that generates a unique value for each data item, wherein each unique value includes a combination of a sibling value and a parent value; and a management system that manages the data items in the relational database using the unique values.

A fourth aspect of the invention provides a computer program product comprising a computer useable medium having computer readable program code embodied therein for managing hierarchical structure data items in a relational database, the program product comprising: program code configured to define a unique value for each data item, wherein each unique value includes a combination of a sibling value and a parent value; and program code configured to manage the data items in the relational database using the unique values.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system for managing hierarchical structure data items according to one embodiment of the invention;

FIG. 2 depicts illustrative values for a hierarchical structure according to an embodiment of the invention; and

FIG. 3 depicts illustrative values for a hierarchical structure according to another embodiment of the invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the invention manages hierarchically related data items in a database by assigning unique values to each data item (i.e., node) in the hierarchy. Each unique value is based on a sibling value and a unique value assigned to the data item's parent. The unique value can be used to identify all relatives (e.g., children, grandchildren, parent, grandparent, siblings, etc.) of a data item based on logical relationships existing amongst the unique values. As a result, data items can be processed in an efficient and non-recursive fashion. A recursive operation is an operation that may call itself one or more times to generate a result. The invention eliminates this requirement while providing efficient processing of data items in a database. For example, all data items located below a selected data item in a tree (i.e., a sub-tree) can be retrieved using a single non-recursive query operation. In a typical embodiment, each sibling in a set of siblings is assigned a sibling value that uniquely identifies it among all the siblings. A data item is assigned a unique value by combining (e.g., concatenating, prefixing, appending, inserting, etc.) its parent's unique value with its sibling value.

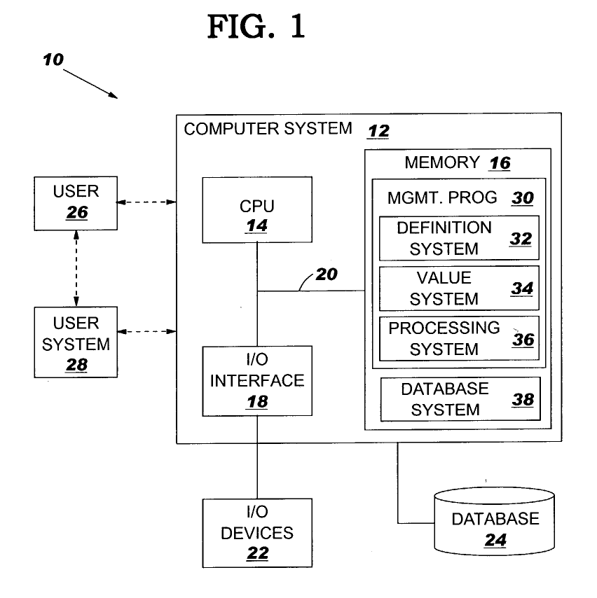

Referring now to FIG. 1, a system 10 for managing hierarchical structure data items in a relational database is depicted. System 10 includes a computer system 12 that generally comprises a central processing unit (CPU) 14, memory 16, input/output (I/O) interface 18, bus 20, I/O devices 22 and database 24. User 26 communicates with computer system 12 using one or more I/O devices 22 or by communicating with user system 28 which in turn communicates with computer system 12. It is understood that although not shown, user system 28 typically contains components (e.g., CPU, memory, etc.) similar to computer system 12. Such components have not been separately depicted and described for brevity purposes. In addition, it is understood that computer system 12 and user system 28 comprise any type of device capable of accepting input, providing output, and/or communicating with another device.

User system 28 communicates with computer system 12 via one or more direct hardwired connections (e.g., serial port), or via an addressable connection in a client-server (or server-server) environment, which may utilize any combination of wireline and/or wireless transmission methods. In the case of the latter, the server and client may be connected via the Internet, a wide area network (WAN), a local area network (LAN), a virtual private network (VPN), or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Computer system 12 can comprise any general purpose or specific-use system utilizing standard operating system software, which is designed to drive the operation of the particular hardware and which is compatible with other system components and I/O controllers. CPU 14 may comprise a single processing unit, multiple processing units capable of parallel operation, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interface 18 may comprise any system for exchanging information with one or more I/O devices 22, including an I/O port (serial, parallel, ethernet, keyboard, mouse, etc.), an universal serial bus (USB) port, expansion bus, integrated drive electronics (IDE), etc. I/O devices 22 may comprise any known type of input/output device capable of communicating with I/O interface 18 with or without additional devices (i.e., expansion cards), including a network system, a modem, speakers, a monitor (cathode-ray tube (CRT), liquid-crystal display (LCD), etc.), hand-held device, keyboard, mouse, voice recognition system, speech output system, scanner, printer, facsimile, pager, storage devices, etc. Bus 20 provides a communication link between each of the components in computer system 12 and likewise may comprise any known type of transmission link, including electrical, optical, wireless, etc. In addition, although not shown, additional components, such as cache memory, communication systems, system software, etc., may be incorporated into computer system 12.

Database 24 may provide storage for information necessary to carry out the present invention as described above. As such, database 24 may include one or more storage devices, such as a magnetic disk drive or an optical disk drive. Further, database 24 can include data distributed across, for example, a LAN, WAN or a storage area network (SAN) (not shown). Database 24 may also be configured in such a way that one of ordinary skill in the art may interpret it to include one or more storage devices.

Shown in memory 16 as computer program code is management program 30 that includes a definition system 32, a value system 34, and a processing system 36. Operation of each system 32, 34, 36 will be discussed further below. Database system 38 is also shown in memory 16 to manage a relational database, for example, database 24. Database system 38 can comprise any relational database management system (RDBMS) now known or later developed. It is understood that management program 30 can be implemented with or without any of systems 32, 34, 36. Further, it is understood that database system 38 can be included as part of management program 30 or implemented as a unique, stand alone program.

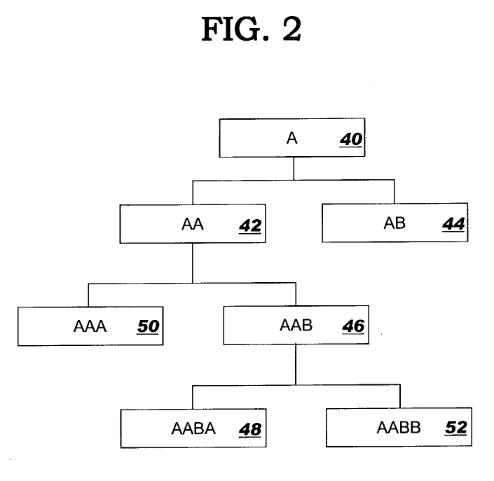

Hierarchically related data items can be considered as residing at nodes in a hierarchical structure. In a hierarchical tree structure (“tree”), a single “root” data item is located at the highest level of the tree. Every data item other than the root data item has a unique “parent” data item, and all data items that are not located at a bottom level of the tree (leaf node) can have one or more “child” data items. FIG. 2 depicts an illustrative tree. The tree includes a root data item 40 that is located at the highest level of the tree. Root data item 40 is a parent for each data item 42, 44 that is located one level below it in the tree. Data items 42, 44 are child data items of root data item 40 and “siblings” of each other since they share the same parent data item. Similarly, data item 46 is a child of data item 42, a parent of data items 48, 52, and a sibling of data item 50. For each data item in the tree, a unique path can be followed from root data item 40 through one or more child data items until the data item is reached. For example, the path to locate data item 48 comprises root data item 40, data item 42, data item 46, and data item 48. A “sub-tree” is defined as a portion of the tree that includes a selected node as its root node. For example, the sub-tree having data item 46 as its root node includes data items 46, 48, and 52.

As noted above, each data item in the tree is assigned a unique value that includes a sibling value. Each child data item of a parent data item is differentiated from its siblings based on the sibling value, which is unique among all siblings (i.e., all children of a parent data item). To generate a unique value, the sibling value is combined with the unique value of the parent data item. It is understood that any number and/or type of values can be used to uniquely identify data items. However, for the purposes of this disclosure, a unique value comprises a string of characters and each sibling value comprises a substring of one or more characters. Accordingly, a unique value may be referred to as a unique string, and a sibling value may be referred to as a sibling string. As shown in FIG. 2, each unique string comprises a combination of the parent's unique string and the sibling string. For example, the unique string for data item 46 comprises the parent's unique string “AA” combined with the sibling string “B” to yield the unique string “AAB.” Similarly, the unique string for data item 50 comprises the parent's unique string “AA” combined with the sibling string “A” to yield the unique string “AAA.”

In the exemplary embodiment depicted in FIG. 1, definition system 32 is used to define the structure of the unique strings based on attributes of the tree. For example, a maximum number of children for any data item can be defined. Based on the maximum number of children, definition system 32 defines an appropriate set of possible sibling strings to uniquely identify each data item in a set of child data items (siblings) in the tree. The structure of each unique string is then defined as a parent's unique string having one of the possible sibling strings appended to it. For example, if the maximum number of children for any data item is less than or equal to twenty-six, the sibling string need only comprise a single letter selected from the set A-Z which is the case in FIG. 2. If additional children are to be allowed, a two letter sibling string comprising any combination of the letters A-Z (i.e., AA, AB, . . . , ZZ) can be used to accommodate a maximum of 676 (26²) children for each data item.

When the length of each sibling string is set, the position of characters in a unique string can be used to determine the level of the tree that they represent. For example, if each sibling string is two characters, the first two characters would represent the top (root) level of the tree, the third and fourth characters would represent the second level, etc. This information can be used to determine the level of the tree on which a selected data item is located. For example, if each sibling string is two characters, and the selected data item is assigned a unique string eight characters long, then the data item is located on the fourth level of the tree.

Value system 34 (FIG. 1) generates and assigns a unique string to each data item in the tree, and subsequently saves each unique string with the respective data item in the database. In the embodiment depicted in FIG. 2, a unique string is generated by combining a sibling string with the unique string assigned to the parent data item. The length of the unique string (i.e., the number of sibling strings that make up the unique string) varies according to the level of the tree on which a node is located. In this embodiment, the sibling string assigned to each sibling for a set of siblings comprises a single character selected from the set A-Z. Characters are selected from the set A-Z in alphabetical order, although it is understood that any ordering can be used. Root data item 40 is initially assigned a sibling string of “A.” Since root data item 40 does not have a parent data item, its unique string is also “A.” The child data items 42, 44 of root data item 40 are each assigned a unique sibling string selected from the set A-Z that is then combined with the unique string of root data item 40 to generate the unique string for each data item 42, 44. For example, data item 44 is assigned “B” as the sibling string to uniquely identify data item 44 among its siblings, which is combined with the unique string (“A”) for its parent data item 40 to generate the unique string “AB” for data item 44. Similarly, data item 42 (“AA”) has children uniquely identified by the unique strings “AAA” and “AAB,” and data item 46 (“AAB”) has children uniquely identified by the unique strings “AABA” and “AABB.” In the current embodiment, the sibling string is concatenated to the right of the parent's unique string. However, it is understood that any means can be used for combining the strings.

Unique strings assigned to hierarchically related data items have a logical relationship. The hierarchical relationship between two data items can be determined based on similarities of their respective unique strings and the length of their respective unique strings. For example, it can be determined that data item 42 (“AA”) is the grandparent of data item 48 (“AABA”) since the length of the unique string assigned to data item 42 is two characters shorter than the length of the unique string assigned to data item 48, and the entire unique string assigned to data item 42 is included at the start of the unique string assigned to data item 48. As a result, data item 42 is two levels above data item 48 and is within the path to data item 48, making data item 42 the grandparent of data item 48. Similarly, it can be determined that data items 48, 52 (“AABA,” “AABB”) are siblings since the unique strings assigned to the respective nodes are the same length and only differ in the last character. The various logical relationships amongst such values can be readily determined.

Processing system 36 (FIG. 1) uses the above-described properties of the unique strings to implement various operations in a relational database using a single non-recursive operation that can be generated by one of ordinary skill in the art. In a typical embodiment, processing system 36 generates standard query language (SQL) commands that are provided to database system 38 (FIG. 1). Database system 38 performs the commands on the data stored in a relational database, and returns the results to processing system 36 for further processing. For example, the level at which a data item is located can be determined by querying the relational database for the length of an assigned unique string and dividing the returned length by the number of characters used in each sibling string.

To identify the parent data item for a selected data item, the sibling string is removed from the unique string assigned to the selected data item. The parent data item can then be identified using the resulting unique string. For example, the parent data item for data item 46 (“AAB”) is identified by removing the “B” sibling string from the unique string resulting in “AA.” The data item having the unique string “AA” assigned to it (i.e., data item 42) is identified as the parent of data item 46. Additional sibling strings can be removed in a similar manner to generate unique strings that can be used to identify any data item along the path to the selected data item. As a result, removing the final two characters (two sibling strings) of the unique string (“AABA”) assigned to data item 48 obtains the unique string (“AA”) assigned to data item 42, the grandparent of data item 48.

Various operations commonly performed on data items require some or all of the data items in a sub-tree of the tree to be identified. For example, data items in a sub-tree can be retrieved (selected), deleted, and/or moved to a different location in the tree. The unique strings allow the necessary identification for these operations to be performed using a single non-recursive operation. To identify data items below a selected data item (i.e., within a sub-tree having the data item at its root), the unique string assigned to the selected data item is used to return the data items that are assigned unique strings that are based on the unique string. For example, in the current embodiment, all data items within the sub-tree having data item 42 at its root are assigned unique strings that start with “AA,” the unique string assigned to data item 42. As a result, requesting all data items having a unique string starting with “AA” would identify the sub-tree that includes data items 42, 46, 48, 50, 52. Identification can be limited to only locate the immediate children, grandchildren, etc. of data item 42 by further limiting the search to the data items assigned unique strings that are N characters longer than the unique string assigned to data item 42, where N is based on the number of characters in each sibling string and the relative level of the desired data items as compared to data item 42. By identifying data items in this manner, a single non-recursive SQL select statement can retrieve all or selected data items in a sub-tree. For example, to retrieve all child data items in the sub-tree having data item 42 (“AA”) as its root, the SQL command SELECT <all> FROM <table> WHERE <unique string starts with “AA”> AND <unique string is three characters long> can be used. Similarly, a single non-recursive SQL delete statement can delete all or selected data items in a sub-tree. For example, to delete all of the data items in the same sub-tree, the SQL command DELETE FROM <table> WHERE <unique string starts with “AA”> can be used. Various modifications to these operations can be generated by one skilled in the art to perform a desired operation.

When a new data item is to be inserted as a child of a selected data item, a unique string must be generated and assigned to the new data item. To generate the unique string, a next available sibling string for the set of children of the selected data item is determined and combined with the unique string assigned to the selected data item. To determine the next available sibling string, the highest unique string assigned to the children of the selected data item can be located by ordering the unique strings assigned to the children, and using the last unique string in the order. The sibling string within the last unique string can be determined, and the next value in the sequence can be used for the sibling string for the new data item. For example, to insert a new data item as a child of data item 42, the highest unique string for the children of data item 42 is located (“AAB”), the sibling string is determined (“B”), and the next character in the sequence (“C”) is used as the sibling string for the new unique string. The next available sibling string is then combined with the unique string assigned to the selected data item to generate the unique string (“AAC”) for the new data item. Because of possible deletions in the child data items, one or more gaps in the sequence of sibling strings may be present. As a result, locating the sibling string may determine the lowest available sibling string in the sequence and use it for the sibling string of the new data item. For example, if the last sibling string in the sequence (i.e., “Z”) is used for a data item, but fewer than all allowed child data items are in the tree (i.e., less than twenty-six), then the sibling strings can be ordered and sequentially searched to locate an available sibling string.

Because of the way string fields in a relational database are defined using a typical database system 38 (FIG. 1), definition system 32 (FIG. 1) may also define a maximum number of levels for the hierarchical structure. Typically, database systems 38 require that a maximum number of characters be specified when defining a field in a table having a string data type. Since each level in the hierarchical structure is represented by one or more characters, the maximum number of levels in the tree that can be stored is directly correlated to the number of characters specified in defining the string in the relational database. For example, if a string field that stores the unique strings is defined to include a maximum of ten characters, then a maximum of ten levels can be stored if a single character is used for each level, or a maximum of five levels can be stored if two characters are used for each level. It is understood that multiple fields can be used to obtain unique strings of any length. As a result, if a relational database only allows a maximum string length of 255 characters, two fields can be used to generate a unique string having a length of over 500 characters.

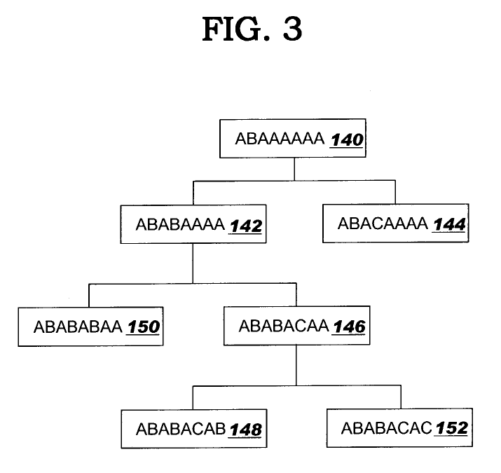

FIG. 3 depicts an alternative method for generating unique strings in which each unique string comprises an identical length string. An identical length string may be easier to process than the variable length string discussed above for some programming environments and/or programming styles. In this case, each level is represented by a two character sibling string and there can be a maximum of four levels in the tree. Each character in the sibling string is obtained from the set A-Z. The sibling strings for a given set of children can be ordered alphabetically (i.e., AA, AB, . . . , AZ, BA, . . . , ZZ).

A unique string for a selected data item is generated using value system 34 (FIG. 1) by combining a unique string assigned to a parent data item with a sibling string that is unique among the siblings of the selected data item. Since the hierarchical structure data items are located at different levels in the tree, one of the possible sibling strings must be reserved to indicate that the data item is located above the level. In this embodiment, “AA” is used in this manner. As a result, a set of siblings are ordered AB . . . ZZ, and a data item can have a maximum of 675 (26²−1) children. For example, the root data item 140 is assigned the initial sibling string “AB” for its set of siblings and the unique string is generated by padding the sibling string with an “AA” sibling string for each level in the tree below root data item's 140 level. Otherwise, unique strings are generated in a similar manner as discussed above with reference to FIG. 2. For example, the unique string for data item 146 is generated by trimming the unique string for its parent data item 142 of all “AA” pairs, obtaining the next available sibling string by trimming the unique string assigned to its sibling data item 150 and locating an unused sibling string, combining the next available sibling string with the trimmed unique string for data item 142, and then adding an “AA” sibling string for the one level below it in the tree. Alternatively, the level for the data item can be determined, and the next available sibling string can be inserted into the unique string assigned to the parent data item in the appropriate location. Since data items 148, 152 are located in the last level of the tree, it is not necessary to pad the unique strings assigned to these data items.

To identify child data items of a selected data item using processing system 36 (FIG. 1), a desired range of unique strings can be specified based on the unique string associated with the selected data item. For example, to retrieve all immediate child data items of data item 144, a query statement can be generated that will return all data items having an associated unique string within the range “ABACABAA” to “ABACZZAA.” Similarly, to retrieve and/or delete all data items within a sub-tree having data item 142 as its root, the range “ABABAAAA” to “ABABZZZZ” would be specified. To exclude data item 142 from the operation, the range would start from “ABABABAA” instead of “ABABAAAA.”

Various other benefits and modifications are recognizable by one skilled in the art, and are covered by the invention. For example, an entire sub-tree can be moved in a single non-recursive operation by changing the portion of the unique values assigned to all data items located in the sub-tree that comprises the unique value for the root node of the sub-tree. Further, the unique values allow data items belonging to multiple trees to be stored in the same table. Since the root data item for each tree is assigned a unique sibling value as if it were one of a set of children, the unique values associated with data items for each tree will start with a unique sibling value.

It is understood that the invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computer system 12 and/or user system 28 such that it carries out the methods described herein. Alternatively, a specific use computer, containing specialized hardware for carrying out one or more of the functional tasks of the invention could be utilized. The invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed:

1. A method of managing hierarchical structure data items in a database comprising:
providing a relational database having hierarchically related data items;
assigning a unique value to each data item, wherein each unique value includes a sibling value; and
identifying all child data items of a selected data item using a single non-recursive operation, wherein the child data items are identified by determining a logical relationship between the unique value assigned to the selected data item and a unique value assigned to each child data item.

2. The method of claim 1, wherein the assigning step includes:
determining a location for a data item in a hierarchical structure; and
assigning the unique value for the data item based on the location.

3. The method of claim 1, further comprising defining a maximum number of levels for the hierarchical structure.

4. The method of claim 1, further comprising defining a maximum number of children for any data item in the hierarchical structure.

5. The method of claim 1, further comprising retrieving a sub-tree of the hierarchical structure using a non-recursive query statement.

6. The method of claim 1, further comprising deleting a sub-tree of the hierarchical structure using a non-recursive delete statement.

7. The method of claim 1, wherein each unique value comprises a unique string.

8. The method of claim 7, wherein the unique string comprises a fixed length string including a sibling string for each level of the hierarchical structure.

9. The method of claim 7, wherein each unique value assigned to a parent data item shares a common substring with all unique values assigned to child data items of the parent data item.

10. The method of claim 1, wherein all sibling values comprise a substring having an identical length.

11. A method of retrieving hierarchical structure data items from a database comprising:
providing a relational database having data items;
generating a unique string for each data item, the unique string including a sibling string;
saving each unique string with an associated data item in the database; and
retrieving all data items below a selected data item using a single non-recursive query based on the unique strings.

12. The method of claim 11, wherein the sibling strings all comprise an identical length.

13. The method of claim 11, wherein the step of retrieving includes searching for a common substring in all unique strings.

14. The method of claim 11, wherein the unique string includes a sibling string for all defined levels of the hierarchical structure.

15. A system for managing hierarchical structure data items in a relational database comprising:
a value system that generates a unique value for each data item, wherein each unique value includes a combination of a sibling value and a parent value; and
a management system that manages the data items in the relational database using the unique values.

16. The system of claim 15, further comprising a database system that manages the relational database.

17. The system of claim 15, further comprising a definition system that defines at least one attribute of the hierarchical structure.

18. A computer program product comprising a computer useable medium having computer readable program code embodied therein for managing hierarchical structure data items in a relational database, the program product comprising:
program code configured to define a unique value for each data item, wherein each unique value includes a combination of a sibling value and a parent value; and
program code configured to manage the data items in the relational database using the unique values.

19. The computer program product of claim 18, further comprising program code configured to manage the relational database.

20. The computer program product of claim 18, further comprising program code configured to define at least one attribute of the hierarchical structure.
